(19) United States
(12) Patent Application Publication
(10) Pub. No.: US 2026/0303974 A1
(43) Pub. Date: Oct. 1, 2026

(54) TRACKING SENSOR USING SHUTTER AS TRACKING INDICATOR AND OPERATING METHOD THEREOF

(71) Applicant: PIXART IMAGING INC., Hsin-Chu County (TW)

(72) Inventors: Boon-How KOK, Penang (MY); Willie SONG, Penang (MY)

(21) Appl. No.: 19/090,400

(22) Filed: Mar. 26, 2025

(51) Int. Cl. H04N 23/695; H04N 23/73

(52) U.S. Cl. CPC H04N 23/695; H04N 23/73

(57) ABSTRACT

There is provided a tracking sensor including a pixel array, a shutter control circuit and a processor. The pixel array acquires an image frame based on a shutter value. The shutter control circuit determines the shutter value based on auto exposure. The processor calculates displacement according to image frames, monitors the determined shutter value, and determines to enter lifted/landed condition according to a shutter delta. The processor further outputs a skating duration and a predicted skating speed to an external MCU to compensate resolution loss in a recovering period.

### FIELD OF THE DISCLOSURE

This disclosure generally relates to a tracking sensor and, more particularly, to an optical tracking sensor using a shutter value variation as a tracking indicator to indicate a change between a bad-tracking-region and a good-tracking-region, and an operating method thereof.

### BACKGROUND OF THE DISCLOSURE

In an application to use an optical sensor as a tracking sensor to repeatedly track successively coming boxes, the optical sensor is arranged to discard displacement data when there is no box appearing in a field of view of the optical sensor. However, when a next box enters the field of view, the optical sensor needs to recover the tracking ability as soon as possible in order not to cause the tracking drift and resolution loss to occur even though the field of view sees a good-tracking-region.

Accordingly, it is required to provide a tracking sensor that is able to recover from an untrackable condition as soon as possible when leaving a bad-tracking-region such that the tracking drift and resolution loss can be avoided.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides an optical tracking sensor that uses a shutter delta as an indicator to indicate a change between a bad-tracking-region and a good-tracking-region, and an operating method thereof.

The present disclosure further provides an optical tracking sensor that uses a shutter delta as an indicator to assist an optical sensor to discard data in facing a bad-tracking-region, and an operating method thereof.

The present disclosure further provides an optical tracking sensor that uses a shutter delta as an indicator to trigger an embedded recovering algorithm after moving out from the bad-tracking-region, and an operating method thereof.

The present disclosure provides a tracking sensor including a pixel array, a shutter control circuit and a processor. The pixel array is configured to acquire an image frame using a shutter value. The shutter control circuit is configured to determine the shutter value based on an auto exposure. The processor is configured to calculate displacement using image frames received from the pixel array, monitor a shutter delta of the shutter value received from the shutter control circuit, and identify that a field of view of the tracking sensor enters an untrackable region upon a first shutter delta being higher than an increasing threshold.

The present disclosure further provides a tracking sensor including a sensor chip. The sensor chip is configured to monitor a shutter delta of a shutter value for acquiring an image frame, output displacement having a value of 0 upon the shutter delta increasing to be higher than an increasing threshold, and enter a recovering period upon the shutter delta increasing to be higher than a decreasing threshold after the shutter delta is higher than the increasing threshold.

The present disclosure further provides an operating method of a tracking sensor, which includes a pixel array and a processor. The operating method includes the steps of: calculating a first shutter delta; comparing the first shutter delta with an increasing threshold; entering a lifted mode upon the first shutter delta being higher than the increasing threshold; calculating a second shutter delta in the lifted mode; comparing the second shutter delta with a decreasing threshold; and entering a recovering period upon the second shutter delta being higher than the decreasing threshold.

### BRIEF DESCRIPTION OF DRAWINGS

Other objects, advantages, and novel features of the present disclosure will become more apparent from the following detailed description when taken in conjunction with the accompanying drawings.

FIG. 1 is a schematic diagram of a tracking system using a tracking sensor according to one embodiment of the present disclosure.

FIG. 2 is a schematic block diagram of a tracking sensor according to one embodiment of the present disclosure.

FIG. 3 is an operational schematic diagram of a tracking sensor according to one embodiment of the present disclosure.

FIG. 4 is a flow chart of an operating method of a tracking sensor according to one embodiment of the present disclosure.

### DETAILED DESCRIPTION OF THE DISCLOSURE

It should be noted that, wherever possible, the same reference numbers will be used throughout the drawings to refer to the same or like parts.

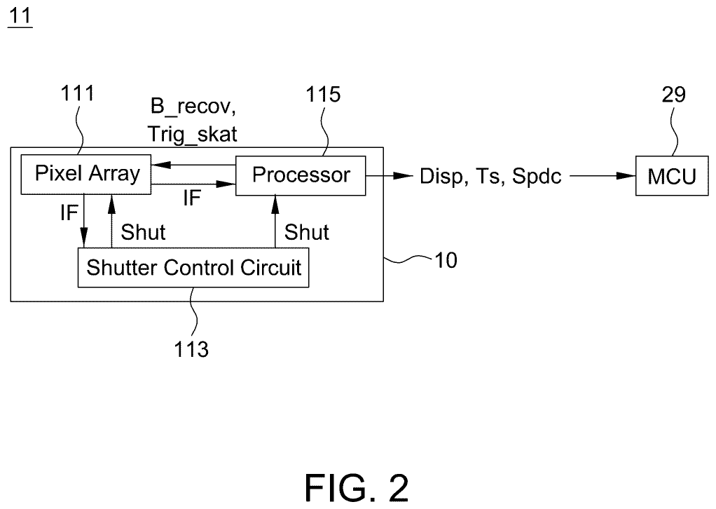

One objective of the present disclosure is to provide an optical tracking sensor that uses a shutter value change to identify a tracking surface change between an untrackable region and a trackable region, and enters a recovering period right after leaving the untrackable region. In the recovering period, the optical tracking sensor determines that the tracking becomes stable after obtaining a predetermined number of correlation peaks (e.g., correlation values larger than a predetermined threshold) so as to recover to a normal operation (outputting calculated displacement, e.g., shown as Disp in FIG. 2 to downstream) such that the issues of tracking drift and resolution loss in the recovering period are overcome. In the present disclosure, the recovering period may be varied corresponding to an object being tracked by the optical tracking sensor.

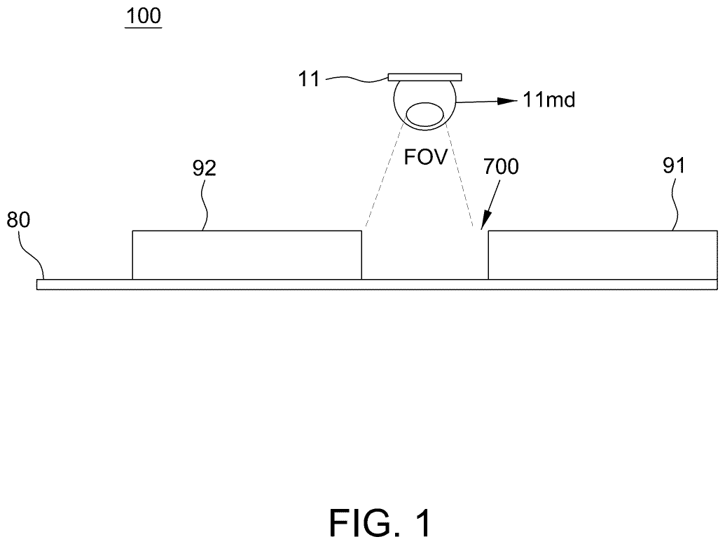

Please refer to FIG. 1, it is a schematic diagram of a tracking system 100 using an optical tracking sensor (abbreviated as tracking sensor herein) 11 according to one embodiment of the present disclosure. The tracking sensor 11 is used to track objects (e.g., shown as 91 and 92, but not limited to two objects) having a related movement with respect to the tracking sensor 11. For example, FIG. 1 shows that the tracking sensor 11 moves in a moving direction 11md with respect to the objects 91 and 92. The types of the objects 91 and 92 are determined according to an application of the tracking system 100. In another aspect, the tracking sensor 11 is fixed at the same position, but the objects 91 and 92 are arranged to move with respect to the tracking sensor 11, e.g., moved by a conveyer belt 80, but not limited thereto.

In either aspect, there is a space 700 between the objects 91 and 92, and the space 700 is referred to an untrackable region or a bad-tracking-region herein. The objects 91 and 92 are referred to trackable regions or good-tracking-regions herein.

Please refer to FIG. 2, it is a schematic block diagram of a tracking sensor 11 according to one embodiment of the present disclosure. In the present disclosure, the tracking sensor 11 includes a sensor chip 10 used to monitor a shutter delta of a shutter value for acquiring an image frame, output displacement having a value of 0 upon the shutter delta increasing to be higher than a first threshold (e.g., an increasing threshold), and enter a recovering period upon the shutter delta increasing to be higher than a second threshold (e.g., a decreasing threshold) after the shutter delta is higher than the first threshold.

For example, the sensor chip 10 includes a pixel array 111, a shutter control circuit 113 and a processor 115. It should be mentioned that although FIG. 2 shows that the shutter control circuit 113 is outside of the processor 115, it is only intended to illustrate but not to limit the present disclosure. In another aspect, the shutter control circuit 113 is included in the processor 115. It is appreciated that operations of the pixel array 111, the shutter control circuit 113 and the processor 115 are considered performed by the sensor chip 10.

The pixel array 111 is, for example, a pixel array of a CMOS image sensor, a CCD image sensor or a SPAD image sensor having multiple pixels arranged in a matrix, and the pixel array 111 is used to acquire an image frame using a shutter value. The shutter control circuit 113 is used to determine the shutter value using an auto exposure (AE) based on image frames captured by the pixel array 111. Details of the auto exposure are known to the art, and thus are not described herein. Simply speaking, when a field of view (FOV) of the tracking sensor 11 covers a trackable region (e.g., 91 or 92 in FIG. 1), the shutter value is at a low level since the pixel array 111 receives enough reflected light from the trackable region; otherwise, when the FOV covers an untrackable region 700, the pixel array 111 does not receive enough reflected light and thus the shutter value becomes higher, e.g., reaching or close to the maximum operable shutter value. More specifically speaking, when the shutter value significantly increases fast, it is considered that an untrackable is detected.

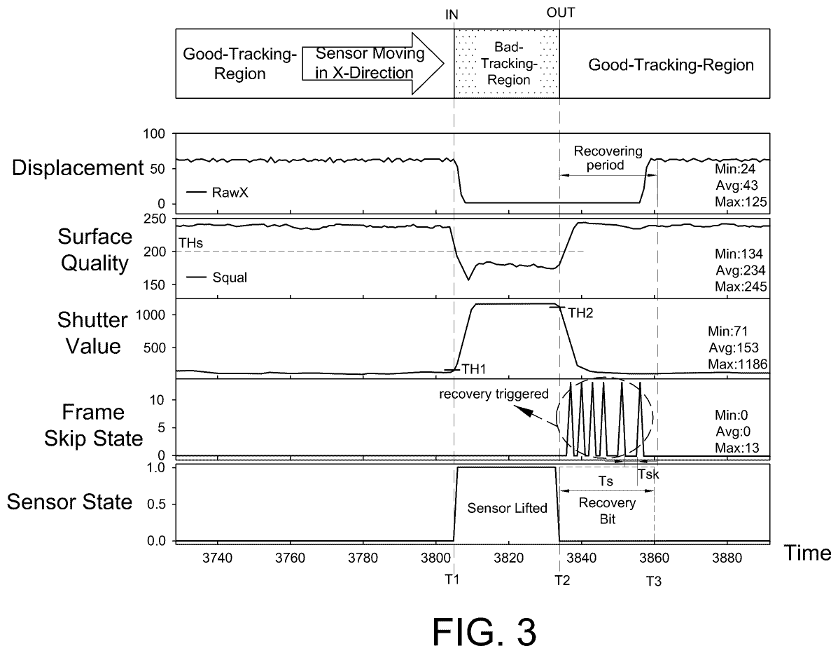

Please refer to FIGS. 1 and 3 together, FIG. 3 is an operational schematic diagram of variations of parameters of a tracking sensor 11 according to one embodiment of the present disclosure. The Good-Tracking-Regions in FIG. 3 is corresponding to a scenario that the FOV of the tracking sensor 11 covers the objects 91 or 92, and the Bad-Tracking-Region in FIG. 3 is corresponding to a scenario that the FOV of the tracking sensor 11 covers the untrackable region 700.

The processor 115 is, for example, a micro controller unit (MCU), an application specific integrated circuit (ASIC), a field programmable gate array (FPGA) or the like that implements functions thereof using software, firmware and/or hardware without particular limitations.

Referring to FIGS. 1 to 3 together, the processor 115 calculates displacement using image frames IF (shown in FIG. 2) received from the pixel array 111, e.g., by comparing two image frames. In the present disclosure, the processor 115 further monitors a shutter delta of the shutter value (shown as Shut in FIG. 2) received from the shutter control circuit 113, and identifies that a field of view of the tracking sensor 11 enters/covers an untrackable region 700 upon a first shutter delta being higher than an increasing threshold, e.g., TH1 shown in FIG. 3.

In one aspect, the increasing threshold TH1 is a first percentage change (i.e. increment) of a first current shutter value prior to entering the untrackable region 700. For example, the processor 115 calculates a first moving average of shutter values (e.g., every five samples, but not limited to five) before a time point T1, at which a bad-tracking region appears in the FOV, as the first current shutter value, and the first percentage change is set as, for example, 40 to 60 percent of the first current shutter value. That is, when the first shutter delta exceeds the first percentage change, the processor 115 confirms that an untrackable region 700 is detected. The first shutter delta is calculated by the processor 115 using a current moving average and a reference moving average, which is calculated by the processor 115 at a time point earlier than obtaining the current moving average by a predetermined time interval, e.g., 10 ms, but not limited to. That is, a moving average obtained prior to the predetermined time interval by the predetermined time interval is recorded in a register as the reference moving average.

The processor 115 outputs displacement having a value of 0 corresponding to the untrackable region 700, e.g., the processor 115 controlling the sensor array 111 not to output image frames IF or not calculating displacement using the image frames IF sent from the sensor array 111 since there is nothing to be tracked within the untrackable region 700. That is, the processor 115 directly outputs displacement having a value of 0 when the untrackable region 700 is confirmed.

In the present disclosure, the processor 115 further identifies that the field of view of the tracking sensor 11 leaves the untrackable region 700 upon a second shutter delta being higher than a decreasing threshold, e.g., TH2 shown in FIG. 3.

In one aspect, the decreasing threshold TH2 is a second percentage change (i.e. decrement) of a second current shutter value within the untrackable region 700. For example, the processor 115 calculates a second moving average of shutter values (e.g., every five samples, but not limited to five) before a time point T2, at which the bad-tracking region leaves the FOV, as the second current shutter value, and the second percentage change is set as, for example, 10 to 20 percent of the second current shutter value. That is, when the second shutter delta (e.g., an absolute value) exceeds the second percentage change, the processor 115 confirms that a trackable region appears again. The second shutter delta is calculated by the processor 115, between T1 and T2, using a current moving average and a reference moving average, which is calculated by the processor 115 at a time point earlier than obtaining the current moving average by a predetermined time interval, e.g., 10 ms, but not limited to. The method of calculating, by the processor 115, the second shutter delta is identical to that of calculating the first shutter delta only within corresponding different surfaces.

In the present disclosure, the processor 115 (or the tracking sensor 11) enters a recovering period upon identifying that the field of view of the tracking sensor leaves the untrackable region 700 at T2 as shown in FIG. 3. Because it is considered that the image quality may not be stable right after the untrackable region 700 is left, the processor 115 is arranged not to directly enter a normal operation but to enter a recovering period during which the processor 115 is arranged to output displacement having a value of 0 so as to avoid the tracking drift. The resolution loss is compensated after the recovering period is over. The normal operation is recovered by further checking the image frames captured, in a pattern different from that in the normal operation, in the recovering period.

In the present disclosure, the processor 115 uses fewer image frames to calculate a correlation peak, e.g., correlation larger than a predetermined threshold, within the recovering period. As shown in FIG. 3, spikes (e.g., six spikes) are referred to skipping a predetermined number of image frames, e.g., 5 to 10 image frames being skipped. For example, the processor 115 sends a trigger signal Trig_skat (shown in FIG. 2) to the sensor array 111 to control the sensor array 111 to stop outputting the predetermined number of image frames IF for a predetermined number of times (e.g., six times shown in FIG. 3, but not limited to) in the recovering period. Or, it is considered that the sensor array 111 is controlled to output image frames at a burst mode, i.e. alternatively not outputting some image frames and continuously outputting some image frames. A time interval Tsk between the skipped image frames IF is determined previously and may be varied, e.g., the time interval Tsk becoming larger at the rear part of the recovering period shown in FIG. 3. However, the time interval Tsk may be set as a fixed value. The processor 115 then calculates correlation peaks using un-skipped image frames, e.g., image frames within Tsk, in the recovering period, and terminates the recovering period upon a predetermined number of correlation peaks being obtained, e.g., 3 to 5 correlation peaks, but not limited thereto. A value of the predetermined number of correlation peaks may be determined according to a response requirement, a frame rate and a related moving speed between the tracking sensor 11 and the objects 91 and 92.

When the predetermined number of correlation peaks is obtained, the processor 115 determines a skating duration Ts indicating that the recovering period is terminated. The processor 115 sends a recovery bit, e.g., shown as B_recov in FIG. 2, to the pixel array 111 to inform the pixel array 111 that the recovering period is ended.

Before entering the untrackable region 700, the processor 115 calculates a moving speed to be recorded in a register to be used as a predict speed, e.g., shown as Spdc in FIG. 2, within the recovering period.

In one aspect, the processor 115 outputs the skating duration Ts and the moving speed Spdc (inch per second) to a downstream processor, e.g., show as MCU 29 in FIG. 2, but not limited to MCU, such that the MCU 29 is able to calculate a compensation movement during the recovering period, e.g., the compensation movement=Ts×Spdc×dots per inch (DPI). The compensation movement indicates a predicted movement within the recovering period. In another aspect, the sensor chip 10 does not send out the skating duration Ts and the moving speed Spdc, but directly calculates the compensation movement by itself, and the sensor chip 10 sends the calculated compensation movement to the MCU 29 to compensate the resolution loss.

In one aspect, the processor 115 records the skating duration Ts into a register for being used in subsequent untrackable regions such that the skating duration Ts is not determined in each untrackable region.

In one aspect, the sensor chip 10 further uses a surface quality as an auxiliary condition to determine whether the tracking sensor 11 should enter a lifted mode (e.g., not operatable) or not. For example, when a current surface quality (calculated using image frames IF by the processor 115, e.g., also using a moving average) is larger than a minimum surface quality threshold THs (shown in FIG. 3), the processor 115 confirms that the lifted mode is not entered. Preferably, in the lifter mode, the current surface quality is lower than the minimum surface quality threshold THs.

In one aspect, the processor 115 increases a minimum surface quality threshold upon entering the untrackable region 700 to make sure that the calculated surface quality is lower than the minimum surface quality threshold within the untrackable region 700.

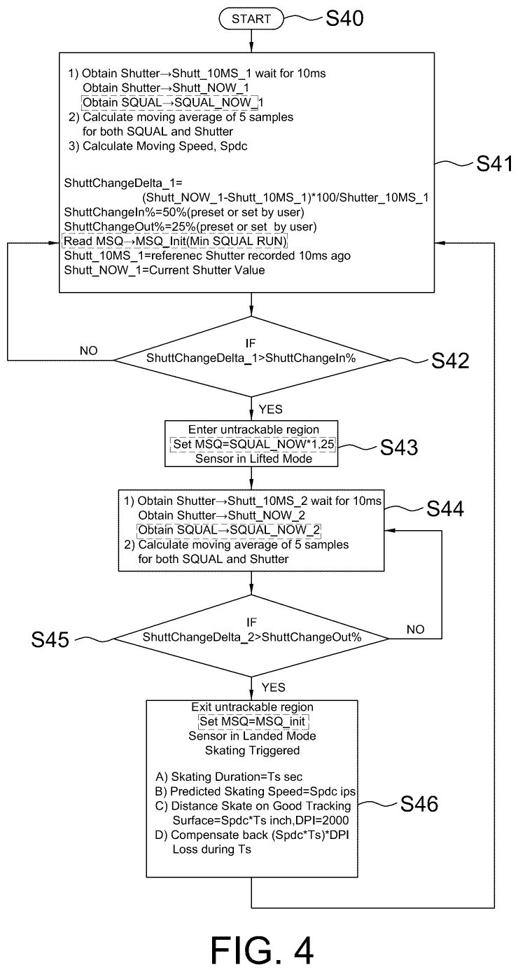

Please refer to FIG. 4, it is a flow chart of an operating method of a tracking sensor 11 according to one embodiment of the present disclosure. The operating method is implemented by embedding a recovering algorithm in the sensor chip 10, and including the steps of: starting the operating method (Step S40); calculating a first shutter delta (Step S41); comparing the first shutter delta with an increasing threshold (Step S42); entering a lifted mode upon the first shutter delta being higher than the increasing threshold (Step S43); calculating a second shutter delta in the lifted mode (Step S44); comparing the second shutter delta with a decreasing threshold (Step S45); and entering a recovering period upon the second shutter delta being higher than the decreasing threshold (Step S46).

Step S40: When a recovering algorithm is run (e.g., the tracking sensor 11 power on), the operating method is started.

Step S41: The sensor chip 10 is preset with an increasing threshold, e.g., shown as ShuttChangeIn % in FIG. 4, and a decreasing threshold, e.g., shown as ShuttChangeOut % in FIG. 4. The increasing threshold and the decreasing threshold may be set as the values mentioned above. In calculating the first shutter delta, the processor 115 firstly calculates a reference shutter value, e.g., shown as Shutt_10MS_1 in FIG. 4, and a current shutter value, e.g., shown as Shutt_NOW_1 in FIG. 4. As mentioned above, the reference shutter value and the current shutter value are moving averages of a predetermined number of samples, e.g., shown as 5 samples in FIG. 4, but not limited thereto. In the Step S41, the processor 115 further calculates and records a moving speed, e.g., shown as Spdc in FIG. 4, prior to entering the lifted mode.

Step S42: The processor 115 then compares the first shutter delta, e.g., shown as ShuttChangeDelta_1 in FIG. 4, and the increasing threshold, i.e., TH1 mentioned above. The operation enters a next step only when the first shutter delta is larger than or equal to the increasing threshold.

Step S43: When the first shutter delta is higher than the increasing threshold, the tracking sensor 11 enters a lifted mode, i.e. untrackable region being confirmed.

Step S44: In the lifted mode, the processor 115 calculates a second shutter delta. The method of calculating the second shutter delta is identical to calculating the first shutter delta, only the second shutter delta being calculated when the FOV of the tracking sensor 11 facing the untrackable region. The processor 115 calculates the second shutter delta using Shutt_10MS_2 and Shutt_NOW_2, e.g., an absolute value of (Shutt_NOW_2-Shutt_10MS_2)×100/Shutt_10MS_2. Similarly, Shutt_10MS_2 and Shutt_NOW_2 are calculated using moving averages of a predetermined number of samples, e.g., shown as five samples, but not limited five.

Step S45: When the second shutter delta is higher than the decreasing threshold, the tracking sensor 11 leaves the lifted mode and enters a landed mode, i.e. trackable region being confirmed.

Step S44: In the landed mode (or the recovering period mentioned above), the processor 115 triggers a skating process, including: skipping a predetermined number of image frames in the recovering period; calculating correlation peaks using un-skipped image frames within the recovering period; and leaving the recovering period upon a predetermined number of the correlation peaks being obtained, e.g., at a time point T3 the recovering period ended. After the recovering period is terminated, the processor 115 determines a skating duration Ts. The skating duration Ts and the moving speed (e.g., shown as predicted skating speed) Spdc calculated and recorded in the Step S41 are used to calculate a compensation movement, e.g., shown as Spdc×Ts×DPI, which is referred to a resolution loss in the recovering period. As mentioned above, to avoid the tracking shift, the processor 115 outputs displacement having a value of 0 within the lifted mode and the recovering period.

In the present disclosure, the surface quality is selected as an auxiliary condition for entering/leaving the lifted mode. In the step S41, the sensor chip 10 is recorded with a minimum surface quality threshold MSQ, e.g., shown as Ths in FIG. 3, to be compared with a current surface quality, e.g., shown as SQUAL_NOW_1. The current surface quality is calculated by the processor 115 using image frames IF captured by the sensor array 111.

In the Step S43, the MSQ is increased in the lifted mode, e.g., shown as MSQ×1.25, but not limited to 1.25. In the Step S44, another current surface quality, e.g., shown as SQUAL_NOW_2 is calculated to be compared with MSQ×1.25. In the Step S46, the MSQ is set back to the initial value in the landed mode, e.g., shown as MSQ_init. In the present disclosure, SQUAL_NOW_1 and SQUAL_NOW_2 also use moving averages. It should be mentioned that said auxiliary condition (surrounded by dashed lines) is optional in the present disclosure.

The tracking sensor 11 of the present disclosure may be adapted to any navigation devices, e.g., moving robot, to compensate a resolution loss behind an untrackable region. The tracking sensor 11 of the present disclosure is not limited to moving in a direction parallel to a surface for putting the object.

It should be mentioned that although the present disclosure is described in the way that the processor 115 outputs dX, a movement in a moving direction (X-direction) of the sensor, as an example, the present disclosure is not limited thereto. In another aspect, the processor 115 may output two-dimensional or three-dimensional displacement to the external MCU 29. The MCU 29 is included in a device or equipment for operating corresponding to information from the tracking sensor 11.

It should be mentioned that values in the drawings and the specification herein are only intended to illustrate but not to limit the present disclosure.

As mentioned above, the tracking sensor is not able to immediately recover from untrackable condition when a bad-tracking-region is over to cause the resolution loss and tracking shift. Accordingly, the present disclosure further provides a tracking sensor (e.g., FIG. 2) and an operating method thereof (e.g., FIG. 4) that determines, using an embedded recovery algorithm, a good-tracking-region and a bad-tracking-region by monitoring a shutter delta and compensates, using embedded recovery algorithm, the resolution loss using a calculated skating duration and a calculated skating speed.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A tracking sensor, comprising:
a pixel array, configured to acquire an image frame using a shutter value;
a shutter control circuit, configured to determine the shutter value based on an auto exposure; and
a processor, configured to
calculate displacement using image frames received from the pixel array,
monitor a shutter delta of the shutter value received from the shutter control circuit, and
identify that a field of view of the tracking sensor enters an untrackable region upon a first shutter delta being higher than an increasing threshold.

2. The tracking sensor as claimed in claim 1, wherein the increasing threshold is a first percentage change of a first current shutter value prior to entering the untrackable region.

3. The tracking sensor as claimed in claim 1, wherein the processor is further configured to
identify that the field of view of the tracking sensor leaves the untrackable region upon a second shutter delta being higher than a decreasing threshold.

4. The tracking sensor as claimed in claim 3, wherein the decreasing threshold is a second percentage change of a second current shutter value within the untrackable region.

5. The tracking sensor as claimed in claim 3, wherein the processor is further configured to
enter a recovering period upon identifying that the field of view of the tracking sensor leaves the untrackable region,
skip a predetermined number of image frames for a predetermined number of times,
calculate correlation peaks using un-skipped image frames within the recovering period, and
terminate the recovering period upon a predetermined number of the correlation peaks being obtained.

6. The tracking sensor as claimed in claim 5, wherein the processor is configured to output the displacement having a value of 0 within the recovering period.

7. The tracking sensor as claimed in claim 5, the processor is further configured to determine a skating duration upon the recovering period being terminated, calculate a moving speed prior to entering the untrackable region, and output the skating duration and the moving speed to a downstream processor.

8. The tracking sensor as claimed in claim 1, the processor is further configured to increase a minimum surface quality threshold upon entering the untrackable region.

9. A tracking sensor, comprising:
a sensor chip, configured to
monitor a shutter delta of a shutter value for acquiring an image frame,
output displacement having a value of 0 upon the shutter delta increasing to be higher than an increasing threshold, and
enter a recovering period upon the shutter delta increasing to be higher than a decreasing threshold after the shutter delta is higher than the increasing threshold.

10. The tracking sensor as claimed in claim 9, wherein the sensor chip is further configured to
output displacement having a value of 0 within the recovering period.

11. The tracking sensor as claimed in claim 9, wherein the sensor chip is further configured to
increase a minimum surface quality threshold upon the shutter delta increasing to be higher than the increasing threshold.

12. The tracking sensor as claimed in claim 9, wherein the sensor chip is further configured to
skip a predetermined number of image frames within the recovering period, and
calculate correlation peaks using un-skipped image frames within the recovering period, and
terminate the recovering period upon a predetermined number of the correlation peaks being obtained.

13. The tracking sensor as claimed in claim 12, wherein the sensor chip is further configured to
determine a skating duration upon the recovering period being terminated, and
calculate a moving speed prior to the shutter delta increasing to be higher than the increasing threshold.

14. The tracking sensor as claimed in claim 13, wherein the sensor chip is further configured to
record the skating duration into a register.

15. An operating method of a tracking sensor, the tracking sensor comprising a pixel array and a processor, the operating method comprising:
calculating a first shutter delta;
comparing the first shutter delta with an increasing threshold;
entering a lifted mode upon the first shutter delta being higher than the increasing threshold;
calculating a second shutter delta in the lifted mode;
comparing the second shutter delta with a decreasing threshold; and
entering a recovering period upon the second shutter delta being higher than the decreasing threshold.

16. The operating method as claimed in claim 15, further comprising:
calculating a moving speed prior to entering the lifted mode.

17. The operating method as claimed in claim 15, further comprising:
skipping a predetermined number of image frames in the recovering period;
calculating correlation peaks using un-skipped image frames within the recovering period; and
leaving the recovering period upon a predetermined number of the correlation peaks being obtained.

18. The operating method as claimed in claim 17, further comprising:
determining a skating duration upon the recovering period being terminated.

19. The operating method as claimed in claim 15, further comprising:
outputting displacement having a value of 0 within the lifted mode and the recovering period.

20. The operating method as claimed in claim 15, further comprising:
increasing a minimum surface quality threshold upon entering the lifted mode.
